(19) United States
(12) Patent Application Publication
(10) Pub. No.: US 2026/0067519 A1
(43) Pub. Date: Mar. 5, 2026

(54) Live Advertising Management

(71) Applicant: Bitmovin GmbH, Klagenfurt am Wörthersee (AT)

(72) Inventors: Adis Talic, Klagenfurt am Wörthersee (AT); Armin Trattnig, Klagenfurt am Wörthersee (AT); Thomas Offner, Klagenfurt am Wörthersee (AT); Patrick Weber, Klagenfurt am Wörthersee (AT); Wolfram Hofmeister, Klagenfurt am Wörthersee (AT)

(73) Assignee: Bitmovin GmbH, Klagenfurt am Wörthersee (AT)

(21) Appl. No.: 19/312,814

(22) Filed: Aug. 28, 2025

Related U.S. Application Data
(60) Provisional application No. 63/689,051, filed on Aug. 30, 2024.

(51) Int. Cl. H04N 21/2668; H04N 21/2187; H04N 21/235

(52) U.S. Cl. CPC H04N 21/2668; H04N 21/2187; H04N 21/235

(57) ABSTRACT

Techniques relating to live advertising management are disclosed. A method for providing content- and user-specific advertising placement includes receiving a video content, encoding the video content using a cloud encoding component, thereby generating encoded video content, extracting content metadata from the video content, generating extracted and advertising-relevant content metadata from the content metadata using an AI model, providing the encoded video content with the extracted and advertising-relevant content metadata to a video player, and determining an advertising placement using a content-aware ad server based on the extracted and advertising-relevant content metadata and a set of user preferences. The extracted and advertising-relevant content metadata may be provided using in-band metadata embedding or out-of-band metadata embedding.

### CROSS-REFERENCE TO RELATED APPLICATIONS

This application claims the benefit of U.S. Provisional Patent Application No. 63/689,051 entitled “Bitmovin Live Advertising Management,” filed Aug. 30, 2024, the contents of which are hereby incorporated by reference in their entirety.

### BACKGROUND OF INVENTION

Conventional advertising placement for live stream applications is at best targeted based on demographics, content type, and other fixed, predetermined information. While dynamic advertisements are sometimes provided, they are often based on other predetermined data such as search history, browsing history, personal data, demographics, and online behavior. However, none of the existing techniques for serving ads to users consider both content metadata and user preferences together for more effective ads placement during video live streaming sessions.

Therefore, improved live advertising management is desirable.

### BRIEF SUMMARY

A system and method are disclosed for live advertising management. A method for providing content- and user-specific advertising placement may include: receiving a video content; encoding the video content using a cloud encoding component, thereby generating encoded video content; extracting content metadata from the video content; generating extracted and advertising-relevant content metadata from the content metadata using an AI model; providing the encoded video content with the extracted and advertising-relevant content metadata to a video player; and determining an advertising placement using a content-aware ad server based on the extracted and advertising-relevant content metadata and a set of user preferences. In some examples, the method also includes providing the extracted and advertising-relevant content metadata to the cloud encoding component. In some examples, the extracted and advertising-relevant content metadata is being provided using in-band metadata embedding. In some examples, the extracted and advertising-relevant content metadata is being provided using out-of-band metadata embedding.

In some examples, the method also includes storing the extracted and advertising-relevant content metadata in a storage bucket adjacent to an output stream. In some examples, the method also includes storing the extracted and advertising-relevant content metadata in a box, a field, or a packet associated with a segment of the video content. In some examples, the extracted and advertising-relevant content metadata comprises one, or a combination, of a keyword, a present object, an audio element, a subject, a mood, and a setting.

In some examples, the method also includes assigning a timestamp to each piece of extracted and advertising-relevant content metadata to enable mapping of said each piece of extracted and advertising-relevant content metadata to a position in the video content. In some examples, the method also includes presenting the advertising placement to a user, the advertising placement comprising a content- and user-specific advertisement. In some examples, determining the advertising placement using the content-aware ad server comprises outputting Interactive Advertising Bureau taxonomies associated with the extracted and advertising-relevant content metadata to the content-aware ad server, the extracted and advertising-relevant content metadata comprising a scene analysis. In some examples, at least some of the extracted and advertising-relevant content metadata is transmitted to the content-aware ad server using a HTTP Live Streaming (HLS) tag. In some examples, determining an advertising placement using a content-aware ad server is further based on a current scene being played by the video player.

A system for providing content- and user-specific advertising placement may include: a memory comprising non-transitory computer-readable storage medium configured to store video data and metadata; one or more processors configured to execute instructions stored on the non-transitory computer-readable storage medium to: receive a video content; encode the video content using a cloud encoding component, thereby generating encoded video content; extract content metadata from the video content; generate extracted and advertising-relevant content metadata from the content metadata using an AI model; provide the encoded video content with the extracted and advertising-relevant content metadata to a video player; and determine an advertising placement using a content-aware ad server based on the extracted and advertising-relevant content metadata and a set of user preferences.

### BRIEF DESCRIPTION OF THE DRAWINGS

Various non-limiting and non-exhaustive aspects and features of the present disclosure are described hereinbelow with references to the drawings, wherein:

FIG. 1 is a simplified block diagram illustrating a live advertising management system, in accordance with one or more embodiments.

FIG. 2 is a flow diagram illustrating an exemplary method for live advertising management, in accordance with one or more embodiments.

FIG. 3A is a simplified block diagram of an exemplary computing system configured to implement the system shown in FIG. 1 and to perform steps of the method illustrated in FIG. 2, in accordance with one or more embodiments.

FIG. 3B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to live advertising management. Live Advertising Management is a system that consists of 4 distinct components that are interconnected to deliver an optimized advertising experience to both the content provider and the content consumer. The core invention is the real-time scene analysis content analysis that is integrated in the encoder, leveraging AI to enrich the content with metadata and seamlessly delivering it to the clients. This is accomplished by analyzing the content at encoding time and extracting advertising relevant metadata from it, encapsulating that metadata into the encoded content and then extracting that metadata in the playout software in order to transmit it to a content aware ad server that can serve relevant ads to the playout software.

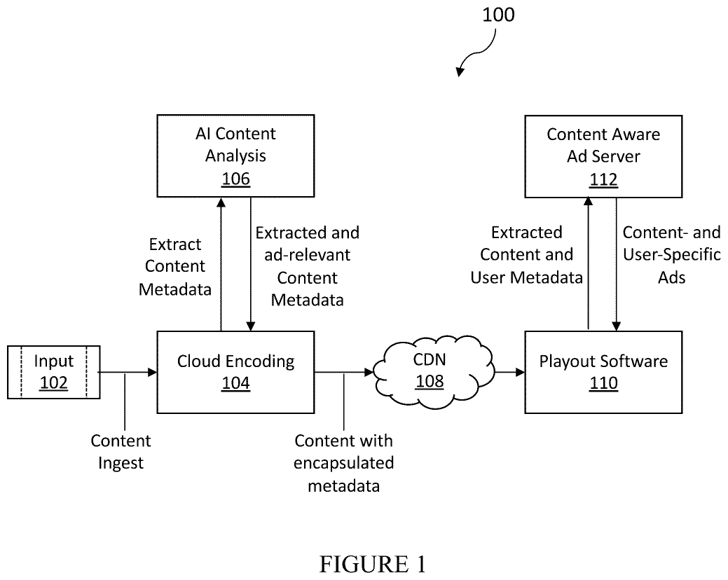

FIG. 1 is a simplified block diagram illustrating a live advertising management system, in accordance with one or more embodiments. Components of system 100 include a cloud encoding component 104, an AI driven content analysis component 106, a playout software 110, and a content aware ad server 112. The cloud encoding component ingests content (either Live or VoD content) and encodes it to prepare it for efficient transmission over the internet. During this encoding process, the cloud encoding component 104 takes the content that is being encoded (e.g., input 102) and analyzes the content to enrich it with advertising relevant metadata.

The basis for the analysis by AI driven content analysis component 106 can either be just the video content of the segment, just the audio content or a mixture of both. For each segment, either just parts of the segment (e.g. individual frames or audio clips) or the full segment (i.e. all video and/or audio samples) may be used for content metadata extraction.

All the metadata (e.g., extracted and ad-relevant content metadata) that is extracted by the AI driven content analysis component 106 is either stored within the segments directly in appropriate boxes/fields/packets, or in separate files that can also be formatted like segments, e.g. subtitle segments or closed captions.

### In-Band Metadata Embedding

For in-band metadata embedding, UUID boxes may be used, as defined in the ISO Base Media File Format (ISO BMFF). UUID boxes provide an extensible mechanism for embedding custom metadata within MP4 containers. Each UUID box contains a 16-byte unique identifier followed by the metadata payload, which can include the AI-extracted scene analysis data in JSON format. This allows the metadata (e.g., extracted and ad-relevant content metadata) to travel with the media segments while maintaining compatibility with the ISO BMFF standard structure.

### Out-of-Band Metadata Delivery

Out-of-band metadata may be delivered via a custom ‘asset description’ file format stored in a storage bucket adjacent to the output stream. This approach allows for more detailed metadata without modifying the media segments themselves. The asset description format can be a JSON structure containing scene-level information with precise timestamps, IAB (i.e., Interactive Advertising Bureau) taxonomies, and comprehensive content descriptions. An example of this format:

```
{
  “scenes”: [
    {
      “title”: “1947 Hollywood Street Scene”,
      “startInSeconds”: 0.0,
      “endInSeconds”: 29.766667,
      “id”: “8eb3leaf-5441-4348-a025-656b5e38d7c4”,
      “content”: {
        “characters”: [
          {
            “appearance”: “Pedestrians in period clothing (men in suits and hats, women in dresses
and coats)”,
            “name”: “”,
            “description”: “Walking on sidewalks and crossing streets.”
          }
        ],
        “objects”: [
          {
            “description”: “Vintage automobiles from the 1940s, including dark sedans, light-colored
coupes, and a light-colored convertible with the top down.”,
            “category”: “Automobiles”
          },
          {
            “description”: “A reddish-brown streetcar visible on the streetcar tracks.”,
            “category”: “Streetcar”
          },
          {
            “description”: “Various signs including ‘J.C. PENNEY CO.’, ‘HOLLYWOOD’,
‘WARNER'S’, ‘BROADWAY HOLLYWOOD’, ‘HOLLYWOOD HOTEL’.”,
            “category”: “Signs”
          },
          {
            “description”: “Mix of architectural styles, including buildings with arched windows,
awnings, marquees, and stylized murals.”,
            “category”: “Buildings”
          },
          {
            “description”: “Characteristic of the Southern California setting.”,
            “category”: “Palm trees”
          }
        ],
        “settings”: [
          {
            “location”: {
              “name”: “Los Angeles, Hollywood”,
              “description”: “A busy city street in Los Angeles, 1947, with iconic Hollywood
landmarks.”
            },
            “timeOfDay”: “Day”,
            “atmosphere”: {
              “mood”: “Bustling, vibrant, active”,
              “lighting”: “Daytime, casting shadows”,
              “weather”: “Hazy, pale blue sky, possibly smoggy”
            }
          }
        ]
      },
      “summary”: “A bustling street scene in 1947 Hollywood, Los Angeles, showcasing vintage
cars, streetcars, pedestrians in period attire, and iconic landmarks.”,
      “sensitiveTopics”: [ ],
      “keywords”: [“Los Angeles”, “1947”, “Hollywood”, “city street”, “vintage cars”, “streetcar”,
“pedestrians”, “architecture”, “Hollywood Hotel”, “Grauman's Chinese Theatre”, “Earl Carroll
Theatre”, “historical”, “urban life”],
      “iab”: {
        “version”: “3.0”,
        “contentTaxonomies”: [“153”, “332”, “EZWB7V”, “648”, “1010”, “5S2VRK”, “1020”],
        “adOpportunityTaxonomies”: [“239”, “338”, “369”, “653”, “660”, “664”, “670”],
        “sensitiveTopicTaxonomies”: [ ]
      },
      “verboseSummary”: “The video segment opens with a broad, panning shot of a bustling city
street, establishing the location as Los Angeles in 1947...”
    }
  ]
}
```

In order to improve the security of the system, the extracted metadata can be stored in an encrypted manner. Any regular DRM protection scheme can in theory be used for metadata encryption for transmitting the decryption key from the cloud encoding component 104 to the Playout Software 110.

In some examples, after encoding by cloud encoding component 104, the content (e.g., with encapsulated metadata) is delivered over CDN 108 just like regular streaming content. The specific encoding and manifest format of the content is irrelevant. The system is able to provide both in-band and out-of-band metadata for all widely used streaming formats.

### AI Driven Content Analysis

The AI Driven Content Analysis component 106 takes the data provided by the Cloud Encoding component 104, including video content, audio content or both audio and video content, and uses an AI model to extract metadata from the content with the goal of enabling a more content focused advertising placement.

The extracted and ad-relevant content metadata can range from keywords, to present objects, to audio elements, and also subjects. The mood and setting can also be extracted. Each extracted piece of content metadata is assigned a timestamp that allows to map that information to the specific position in the content from which it is extracted and to which it is associated. The extracted and ad-relevant content metadata shall describe the content in sufficient detail to allow for targeted ad placement, but it can also describe the scene in a more general way. A sample metadata extraction may look like this:

```
{
  “characters”: [
    {
      “appearance”: “Middle-aged man, late 50s/early 60s, thinning hair, white shirt, tie,
suspenders, weathered face.”,
      “name”: null,
      “description”: “Stands in a dimly lit office, smoking a cigarette, contemplating a
disappearance.”
    },
    {
      “appearance”: “Pedestrians in mid-century attire.”,
      “name”: null,
      “description”: “Walking along Hollywood Boulevard in 1947.”
    }
  ],
  “objects”: [
    {
      “description”: “Classic cars from the 1940s.”,
      “category”: “Automotive”
    },
    {
      “description”: “Cigarette”,
      “category”: “Personal”
    },
    {
      “description”: “Desk lamp”,
      “category”: “Office Supplies”
    },
    {
      “description”: “Clock on the wall”,
      “category”: “Home Decor”
    },
    {
      “description”: “Small fan”,
      “category”: “Home Appliances”
    },
    {
      “description”: “Filing cabinet”,
      “category”: “Office Supplies”
    }
  ],
  “settings”: [
    {
      “location”: {
        “name”: “Hollywood Boulevard”,
        “description”: “A bustling street in 1947, lined with iconic buildings and filled with classic
cars and pedestrians.”
      },
      “timeOfDay”: “Day”,
      “atmosphere”: {
        “mood”: “Nostalgic, vibrant”,
        “lighting”: “Bright, slightly faded”,
        “weather”: “Clear”
      }
    },
    {
      “location”: {
        “name”: “Dimly Lit Office”,
        “description”: “A claustrophobic office filled with shadows, illuminated by a desk lamp and
light filtering through blinds.”
      },
      “timeOfDay”: “Night”,
      “atmosphere”: {
        “mood”: “Mysterious, somber”,
        “lighting”: “Dim, stark contrasts”,
        “weather”: “N/A”
      }
    }
  ]
}
```

A more general scene description can be used later on to enhance the accessibility of the content without having to rely on manual content annotations like closed captions or subtitles. Such extracted and ad-relevant content metadata can also be used for content indexing or scene specific seeks where the user can search for a specific scene, object or person instead of to a specific time. All the extracted and ad-relevant content metadata that is extracted from the content by the AI Driven Analysis component 106 is transmitted back to the Cloud Encoding component 104 to be included with encoded content being sent to playout software 110 via CDN 108 (e.g., sent to CDN 108 and loaded by playout software 110).

### Playout Software

The Playout Software component 110 may load an encoded stream from CDN 108, just like with any other streaming format, and may extract the in-band or out-of-band metadata from the content. It then uses the extracted and ad-relevant content metadata (e.g., that is encapsulated with encoded content from cloud encoding component 104), together with user specific metadata, which may be collected on either the playout side or the server side of the content provider, to send advertisement placement requests to the Content Aware Ad Server 112.

Once the Content Aware Ad Server 112 responds with ad placements that suit both the content as well as the user, the playout software 110 can present a content- and user-specific advertisement to the user. The rest of the playout process is the same as with regular client-side ad insertion.

### Content Aware Ad Server

The Content Aware Ad Server component 112 is responsible for finding a suitable ad placement given the metadata (e.g., extracted and ad-relevant content metadata and user preferences) that is supplied by the Playout Software 110. It aims at serving ads that fit both the content as well as the user's preferences to maximize user engagement and conversion rate.

The integration with the ad server is designed to be ad-server agnostic, as the specific ad server is not provided by this system. One of ordinary skill in the art would understand that the specific implementation depends on the particular ad server being used. The scene analysis may output IAB content taxonomies, which are then passed to the ad server.

One option for transmitting the metadata is directly within the manifest using HTTP Live Streaming (HLS) tags. For example, the metadata can be embedded as an EXT-X-ASSET tag, e.g.: #EXT-X-ASSET:SCENE_TITLE=“1947%20Los%20Angeles%20Street%20Scene”,KEYWORDS=“Los %20Angeles%2C1947%2Cvintage%2Cstreet%20scene%2CHollywood%2Cnostalgia%2Cmyste ry%2Ccars%2Cpedestrians%2Carchitecture”,IAB=“153%2C324%2C647%2C655%2C660%2C112”

This allows the metadata to be transmitted alongside the media segments in the HLS manifest, enabling the ad server to make content-aware decisions based on the current scene being played.

The specific ad selection logic and matching algorithms may be determined by the ad server's internal implementation. The role of this system is to provide rich, contextual metadata about the content (e.g., extracted and ad-relevant content metadata)—including scene descriptions, objects, characters, mood, settings, and IAB taxonomies—that enables an ad server to make more informed decisions about ad placement. This enhanced context allows for more relevant ad selection, potentially improving conversion rates and user engagement. Content aware ad server 112 can utilize its own algorithms, AI services, or even GenAI to process this metadata and determine optimal ad placements based on both the content context and user preferences.

### Example Methods

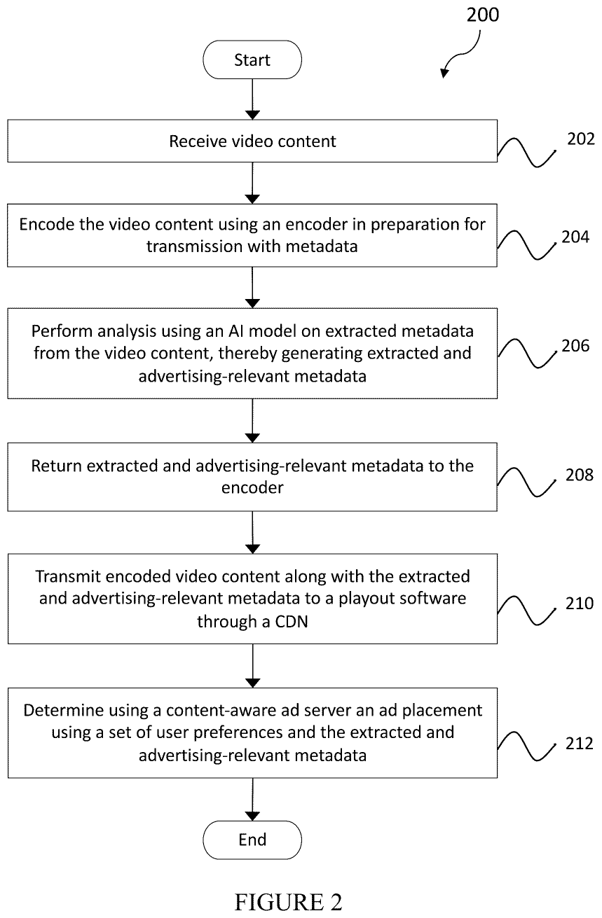

FIG. 2 is a flow diagram illustrating an exemplary method for live advertising management, in accordance with one or more embodiments. Method 200 may begin with receiving (e.g., ingesting) video content at step 202 (e.g., by cloud encoding component 104). The video content may be encoded using an encoder in preparation for transmission with metadata to a video player (e.g., playout software 110) at step 204. Content metadata may be extracted and provided to an AI-driven content analysis component, as described herein, such that an analysis may be performed using an AI model at step 206. This step may generate advertising-relevant metadata (e.g., extracted and ad-relevant content metadata) that is returned to the encoder at step 208. Encoded video content with the extracted and advertising-relevant metadata may be transmitted to a playout software through a CDN at step 210. In some examples, the encoded video content, along with its extracted and ad-relevant content metadata, are transmitted to a CDN, and a playout software or other video player software may load the encoded video content from the CDN. An ad placement may be determined using a content-aware ad server based on a set of user preferences and the extracted and advertising-relevant metadata at step 212.

### Example Computing Systems

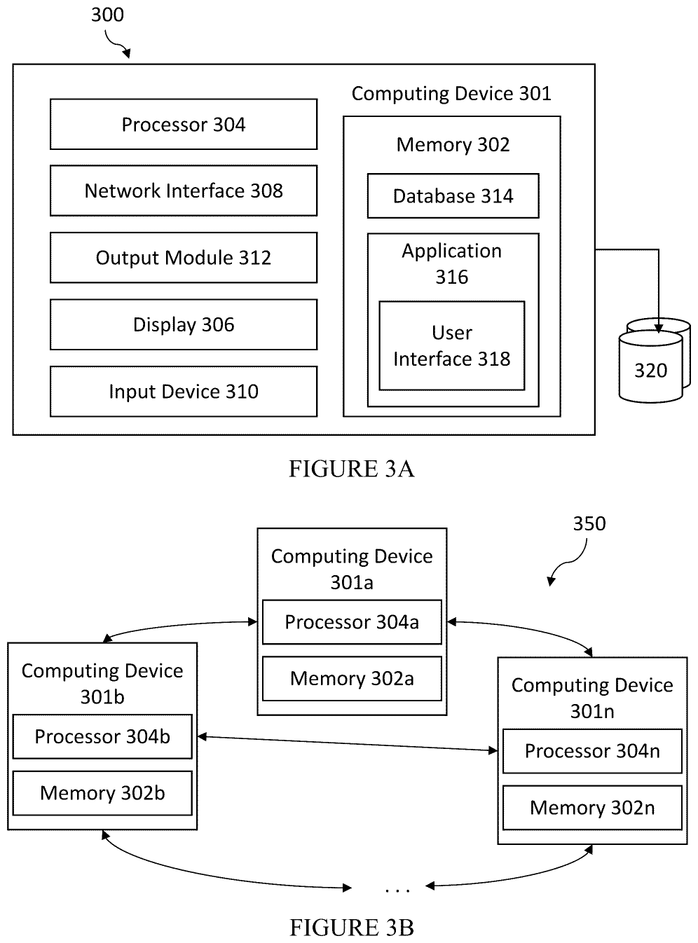

FIG. 3A is a simplified block diagram of an exemplary computing system configured to implement the system shown in FIG. 1 and to perform steps of the method illustrated in FIG. 2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301. In some examples, storage system 320 may store video data (e.g., frames, segments, extracted metadata, etc.), codecs, user preferences, advertisements, instructions, programs, and other various types of information as described herein. This information may be retrieved or otherwise accessed by one or more computing devices, such as computing device 301, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., content-aware models, other DNNs, etc.) and other AI models, data regarding encoding, video content, content metadata, user preferences, advertisements, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In one embodiment, computing device 301 is a data center or other control facility (e.g., configured to run a distributed computing system as described herein), and may communicate with a media playback device or other video player or client device. As described herein, system 300, and particularly computing device 301, may be used for encoding video, extracting, analyzing, and generating metadata, determining advertisement placement, and otherwise implementing steps in live advertising management, as described herein. Various configurations of system 300 are envisioned, and various steps and/or functions of the processes described herein may be shared among the various devices of system 300 or may be assigned to specific devices.

FIG. 3B is a simplified block diagram of an exemplary distributed computing system implemented by a plurality of the computing devices, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3A, as described above. Memory 302a-n may function similarly to memory 302 in FIG. 3A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for providing content- and user-specific advertising placement comprising:
receiving a video content;
encoding the video content using a cloud encoding component, thereby generating encoded video content;
extracting content metadata from the video content;
generating extracted and advertising-relevant content metadata from the content metadata using an AI model;
providing the encoded video content with the extracted and advertising-relevant content metadata to a video player; and
determining an advertising placement using a content-aware ad server based on the extracted and advertising-relevant content metadata and a set of user preferences.

2. The method of claim 1, further comprising providing the extracted and advertising-relevant content metadata to the cloud encoding component.

3. The method of claim 2, wherein the extracted and advertising-relevant content metadata is being provided to the cloud encoding component using in-band metadata embedding.

4. The method of claim 2, wherein the extracted and advertising-relevant content metadata is being provided to the cloud encoding component using out-of-band metadata embedding.

5. The method of claim 1, further comprising storing the extracted and advertising-relevant content metadata in a storage bucket adjacent to an output stream.

6. The method of claim 1, further comprising storing the extracted and advertising-relevant content metadata in a box, a field, or a packet associated with a segment of the video content.

7. The method of claim 1, wherein the extracted and advertising-relevant content metadata comprises one, or a combination, of a keyword, a present object, an audio element, a subject, a mood, and a setting.

8. The method of claim 1, further comprising assigning a timestamp to each piece of extracted and advertising-relevant content metadata to enable mapping of said each piece of extracted and advertising-relevant content metadata to a position in the video content.

9. The method of claim 1, further comprising presenting the advertising placement to a user, the advertising placement comprising a content- and user-specific advertisement.

10. The method of claim 1, wherein determining the advertising placement using the content-aware ad server comprises outputting Interactive Advertising Bureau taxonomies associated with the extracted and advertising-relevant content metadata to the content-aware ad server, the extracted and advertising-relevant content metadata comprising a scene analysis.

11. The method of claim 1, wherein at least some of the extracted and advertising-relevant content metadata is transmitted to the content-aware ad server using a HTTP Live Streaming (HLS) tag.

12. The method of claim 1, wherein determining an advertising placement using a content-aware ad server is further based on a current scene being played by the video player.

13. A system for providing content- and user-specific advertising placement comprising:
a memory comprising non-transitory computer-readable storage medium configured to store video data and metadata;
one or more processors configured to execute instructions stored on the non-transitory computer-readable storage medium to:
receive a video content;
encode the video content using a cloud encoding component, thereby generating encoded video content;
extract content metadata from the video content;
generate extracted and advertising-relevant content metadata from the content metadata using an AI model;
provide the encoded video content with the extracted and advertising-relevant content metadata to a video player, and
determine an advertising placement using a content-aware ad server based on the extracted and advertising-relevant content metadata and a set of user preferences.
